(19) United States
(12) Patent Application Publication
(10) Pub. No.: US 2015/0048054 A1
(43) Pub. Date: Feb. 19, 2015

(54) ELECTRICAL CONTACT SYSTEM

(71) Applicant: General Electric Company, Schenectady, NY (US)

(72) Inventors: Nagaveni KARKADA, Bangalore (IN); Gopi Chandran RAMACHANDRAN, Bangalore (IN); Thangavelu ASOKAN, Bangalore (IN)

(21) Appl. No.: 14/458,296

(22) Filed: Aug. 13, 2014

(30) Foreign Application Priority Data
Aug. 16, 2013 (IN) 3637/CHE/2013

(51) Int. Cl. H01H 33/10; H01H 11/04

(52) U.S. Cl. CPC H01H 33/10; H01H 11/048
USPC 218/146; 29/875

(57) ABSTRACT

A system including a contact tip that includes an arcing surface, a base surface, and a graded structure is presented. The graded structure includes a first region comprising a first surface proximate to the arcing surface, a second region comprising a second surface proximate to the base surface, and an intermediate region disposed between the first region and the second region. A concentration of silver in the graded structure decreases from the first surface to the second surface. A method of forming a contact tip includes preparing starting materials for a first region, an intermediate region, and a second region of the contact tip. The starting materials of the first, intermediate, and second regions are sequentially added to a container to form a graded blend of starting materials. The graded blend of starting materials are compacted and heat-treated to form a contact tip having a graded structure.

### BACKGROUND

The present invention relates generally to a contact arm assembly having an electrical contact in an electrical circuit breaker.

Contacts and contact arm assemblies are well known in the art of circuit breakers. Contact arm assemblies having electrical contacts for making and breaking an electrical current are not only employed in electrical circuit breakers, but also in other electrical devices, such as rotary double break circuit breakers, contactors, relays, switches, and disconnects. The applications that these electrical devices are used in are vast and include, but are not limited to, the utility, industrial, commercial, residential, and automotive industries.

The primary function of a contact arm assembly is to provide a carrier for an electrical contact that is capable of being actuated in order to separate the contact from a second contact and contact arm arrangement, thereby enabling the making and breaking of an electrical current in an electric circuit. Electrical contacts suitable for the noted applications typically include silver.

The contact is generally bonded to the contact arm, which is typically, but not necessarily, a copper alloy, in such a manner that the assembly tolerates the thermal, electrical and mechanical stresses and will not disassemble during operation of the host device. Predominantly the contact failure occurs due to wear and tear. Factors that normally affect contact and trigger wear and tear are configuration or geometry of contact (different layer/thickness), materials choice, and processing (brazing/welding) that creates voids at the interface. Hence there is a need for improved assembly of the contacts with high interfacial quality. The system and method presented herein are directed towards addressing this need.

### BRIEF DESCRIPTION

In one embodiment, a system is presented. The system includes a contact tip that includes an arcing surface, a base surface, and a graded structure between the arcing surface and the base surface. The graded structure includes a first region comprising a first surface proximate to the arcing surface, a second region comprising a second surface proximate to the base surface, and an intermediate region disposed between the first region and the second region. Further, a concentration of silver in the graded structure decreases from the first surface to the second surface.

In one embodiment, a method of forming a contact tip is presented. The method includes preparing starting materials for a first region, an intermediate region, and a second region of the contact tip. The starting materials of the first, intermediate, and second regions are sequentially added to a container to form a graded blend of starting materials. The graded blend of starting materials are compacted and heat-treated to form a contact tip having a graded structure. The graded structure has a concentration of silver decreasing from the first region to the second region.

### BRIEF DESCRIPTION OF DRAWINGS

FIG. 1 is a schematic diagram of a system including a contact tip, in accordance with one embodiment of the invention;

FIG. 2 is a schematic diagram of a system including one distinctly graded structure, in accordance with one embodiment of the invention;

FIG. 3 is a schematic diagram of a system including one continuously graded structure, in accordance with one embodiment of the invention; and

FIG. 4 is a scanning electron micrograph of a graded structure, in accordance with one embodiment of the invention.

### DETAILED DESCRIPTION

The systems and methods described herein include embodiments that relate to a contact arm assembly having an improved bond between contact and contact arm, thereby enabling the contact arm assembly to withstand thermal, electrical, and mechanical stresses.

In the following specification and the claims that follow, the singular forms “a”, “an” and “the” include plural referents unless the context clearly dictates otherwise.

As used herein, the term “adjacent” or “proximate” when used in context of discussion of different compositions or structure of regions or surfaces refers to “immediately next to” and it also refers to the situation wherein other components that are present between the components under discussion do not vary much with regards to the compositions or structure respectively of at least any one of the components.

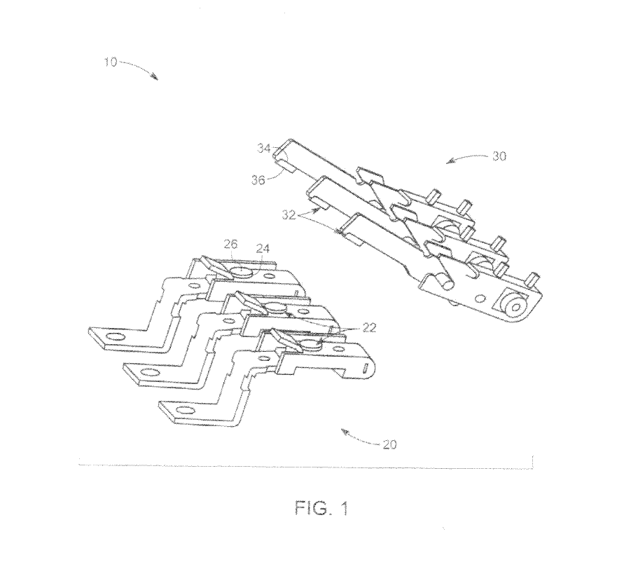

Referring now to FIG. 1, an exemplary circuit breaker system 10 is shown. The circuit breaker system 10 includes a stationary arm 20 having a fixed contact tip 22 having a fixed base surface 24 and fixed arcing surface 26. The circuit breaker system further includes a moving arm 30 having a movable contact tip 32 having a movable base surface 34 and movable arcing surface 36. The base surfaces 24, 34 of the contact tips 22, 32 are attached to the contact arms 20, 30, and the arcing surfaces 26, 36 are the free surfaces.

During operation, an electric arc occurs between two contact tips 22 and 32 at the arcing surfaces 26, 36 whenever fault current or short circuit happens. The high heat produced by the electric arc may melt both arcing surfaces 26 and 36 and a poor contact between the base 24, 34 and the arcing surfaces 26, 36 may result in transfer of contact materials from one tip to another producing uneven arcing surfaces or carbon slag on the surfaces. The carbon slag produced may adhere to the arcing surfaces 26, 36 and decrease electrical conductivity of the contact subjecting the arcing surfaces 26, 36 to mechanical and electrical degradation. Therefore, it is desired to configure the contact tips 22, 32 with an appropriate hardness, high wear resistance, high temperature stability, and a good bonding between the base surfaces 24, 34 and arcing surfaces 26, 36. Further, the arcing surfaces are desired to be generally inert to oxygen and sulfur reactions.

As alluded above, reliability of contact tips 22, 32 is desired for the increased life of the electrical switch gear. Wear and tear of contacts may be reduced by change in configuration, materials choices, and/or processing. Methods such as extrusion, die compacting, molding are commonly used for manufacturing of arcing surfaces 26, 36. The arcing surfaces 26, 36 are normally brazed or welded on a copper base 24, 34 in most of the conventional electrical switch gears. Different embodiments of the present invention provide contact tips 22, 32 having graded structure between the base surface and arcing surface, and a new method of fabricating the contact tips 22, 32 without using brazing or welding and thereby eliminating voids in the contact tip 22, 32 structure.

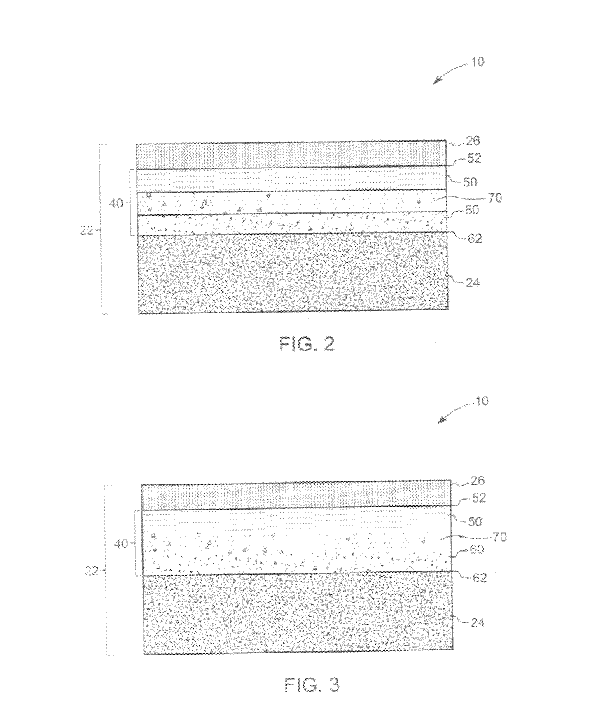

In one embodiment, a circuit breaker system 10 includes a graded structure 40 between the base surface and arcing surface of the fixed contact tip 22 or movable contact tip 32 as shown in FIG. 2. As used herein, the “graded structure between base surface and arcing surface” means that the structure between the base surface and the arcing surface has a gradient from base surface to arcing surface or vice versa. The term “gradient” as used herein means the value of a characteristic parameter of the structure changes with a change in position in the direction from base surface to arcing surface. The characteristic parameter may be composition, density, thickness, reactivity, or microstructure, for example. In one embodiment, the gradient is in the composition of the graded structure.

In one embodiment, both the fixed contact tip 22 and movable contact tip 32 include the graded structure 40. Embodiments described herein use the example of fixed contact tip 22 as having the graded structure 40, while the movable contact tip 32 may or may not have a similar configuration. The graded structure 40 includes a multilayer architecture including a first region 50 proximate to the arcing surface, a second region 60 proximate to the base surface, and an intermediate region 70 disposed between the first region and the second region. The first region 50 includes a first surface 52 facing the arcing surface 26 and the second region 60 includes a second surface 62 facing the base surface 24. The graded structure may optionally have further intermediate regions in between the first and second regions.

In one embodiment, the graded structure 40 includes the first region 50, second region 60, and the intermediate region 70 in distinct, but integrated structure as shown in FIG. 2. In one embodiment, the first region 50, second region 60, and intermediate region 70 are seamless structures integrated to one another according to their layered positions as shown in FIG. 3, but are not distinctly separate in structure from the adjacent regions. The graded structure in this embodiment has a continuously graded structure. The interfaces of continuously graded structures may not be apparent at the macroscopic level, but may have interfaces of layers that can be identified at microscopic scale.

The distinct or continuous multilayer architecture described herein is configured to be free of defects or voids and designed to be robust towards wear. This multilayer structure has superior mechanical strength, heat dissipation, and electrical performance over the current design of contacts. The graded architecture promotes reliable contact configuration, and may be formed by additive manufacturing, thereby eliminating brazing or joining of metals.

Silver is considered to be an excellent contact tip 22 material because of its high thermal and electrical conductivity and considerable inertness to oxygen, nitrogen, and sulfur. However silver has a low melting point, making it prone to fusion and sticking. Further, silver is an expensive material to be used in large quantities. To overcome these challenges, in one embodiment, silver alloys or metal mixtures are used along with silver to increase hardness.

In one embodiment, silver is used as the arcing surface 26, and a concentration of silver in the graded structure 40 decreases from the first surface 52 to the second surface 62. For example, in an embodiment in which graded structure 40 has a distinct multilayered structure, the silver may be decreased from the first surface 52 to the second surface 62 in a stepwise manner. In an embodiment where the layers are in a continuous gradation from the first surface 52 to the second surface 62, the concentration of silver may be continuously decreased from the first surface 52 to the second surface 62. Similarly, a concentration of copper in the graded structure 40 may decrease from the second surface 62 to the first surface 52. In one embodiment, the arcing surface 26 includes substantially 100% silver, and the graded structure 40 may have different regions with decreasing percentage of silver from the first region 50 to the second region 60, and the second surface 62 is substantially free of silver. In one embodiment, the base surface 24 includes substantially 100% copper.

As used herein, “substantially 100%” is used to define the intended 100% composition, but may include any impurities that would not unduly degrade the arcing surface 26 or base surface 24 performance, and further would include any impurities that would have incidentally became incorporated at the surfaces during processing. In one embodiment, the concentration of silver in the arcing surface 26 is greater than about 98% and the concentration of the copper in the base surface 24 is greater than 98%. As used herein the percentages mentioned are weight percentages.

The graded structure 40 used herein may be composed of metals, metal alloys, metal oxides, carbides, or nitrides. In one embodiment, the graded structure 40 includes tungsten, molybdenum, nickel, carbon, or any combinations thereof. The graded structure 40 may include a metal mixture of any of these elements with silver or copper as a part of one or more regions of the graded structure 40. A “metal mixture” as used herein is a mixture of silver or copper with a metal, non-metal, an alloy, or a compound of metal and non-metal. Thus, in one embodiment, the metal mixture may have silver-graphite (alternately silver-carbon) in a mixture form, where the silver and carbon do not generally react with each other to form a compound. In one embodiment, the silver may be in a mixture form with tungsten carbide.

In one embodiment, the metal mixture includes a metal carbide, a silver-tungsten alloy, a silver-nickel alloy, silver-tungsten carbide composite, silver-molybdenum composite, or any combinations of these. In one embodiment, the graded structure 40 has an increasing gradation in the composition of the metal mixture from the surfaces to the center of the graded structure 40. A weight averaged concentration of the metal mixture in the intermediate region 70 of the graded structure 40 may be substantially higher than the concentration of the metal mixture at the first or second regions, when compared to the concentration of silver or copper in the respective regions.

In one embodiment, nickel, carbon, tungsten, molybdenum, and tungsten carbide were studied as individual metal mixtures along with silver, copper, or silver and copper. In one example, the first region 50 includes a silver-nickel metal mixture; the intermediate region 70 includes a silver-copper-nickel metal mixture; and the second region 60 is substantially copper.

In another example, the first region 50 includes a silver-tungsten metal mixture with 35/65 respective weight percentage ratio, the intermediate region 70 includes a silver-copper-tungsten metal mixture with 15/20/65 respective weight percentage ratio, and the second region 60 is substantially copper.

In one more example, the first region 50 includes a silver-graphite metal mixture with 95/5 respective weight percentage ratio, the intermediate region 70 includes a silver-copper-carbide metal mixture with 70/25/5 respective weight percentage ratio, and the second region 60 is substantially copper.

In yet another example, the first region 50 includes a silver-tungsten carbide metal mixture with 35/65 respective weight percentage ratio, the intermediate region 70 includes a copper-tungsten carbide-tungsten metal mixture with 15/20/65 respective weight percentage ratio, and the second region 60 is substantially copper.

In a further example, the first region 50 includes a silver-tungsten carbide metal mixture, the intermediate region 70 includes a silver-copper-tungsten carbide metal mixture, and the second region 60 is substantially copper.

In one more example, the first region 50 includes a silver-tungsten carbide metal mixture, the intermediate region 70 includes a copper-tungsten carbide metal mixture, and the second region 60 is substantially copper.

In one more example, the first region 50 includes a silver-tungsten carbide metal mixture, the intermediate region 70 includes a silver-copper-tungsten carbide metal mixture, and the second region 60 includes a copper-tungsten carbide metal mixture.

In one more example, the first region 50 includes a silver-tungsten carbide metal mixture, the intermediate region 70 includes a copper-tungsten carbide-tungsten metal mixture, and the second region 60 includes a copper-tungsten carbide metal mixture.

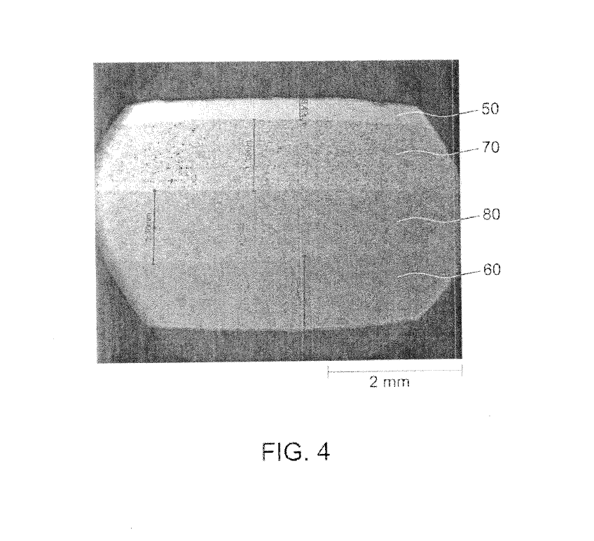

FIG. 4 depicts a scanning electron micrograph (SEM) of a graded structure 40. The graded structure includes multiple layers of different concentrations of silver and copper. For example, the first region 50 is of 100% silver, and the second region 60 is of 100% copper. The intermediate regions 70 and 80 vary in the concentration of silver and copper in these layers. For example, layer 70 includes higher concentration of silver than copper and the region 80 includes lower concentration of silver than the amount of copper in that surface.

The contact tip having graded structure 40 may be formed using specific processes that facilitate voidless joining or forming of different regions of the graded structures. For example, methods such as cold pressing, hot pressing, and hot isostatic pressing (HIP) may be used for the formation of graded structure 40.

In one embodiment, powders of different layers are individually blended, arranged in the desired layer configuration and compacted using uniaxial press. The compacted blends may be sintered in an inert atmosphere at a temperature in a range from about 650° C. to about 1000° C. Silver may be infiltrated into the pores of the compacted and sintered structure to fill the pores with silver and to deposit silver on the first surface.

Alternately, a graded pore structure may be formed in the graded structure using different types and concentrations of binders during the compaction of the individual layer powders or blends. These binders during sintering evaporate and leave behind pores that can be later filled with the arcing surface material such as, for example, silver.

In one embodiment, the powder blends arranged in layered configuration may be subjected to HIP or spark plasma sintering to join the different layers together, thus making an integral contact tip 22.

### EXAMPLES

The following examples illustrate materials, methods, and results, in accordance with specific embodiments, and as such should not be construed as imposing limitations upon the claims. All components are commercially available from common suppliers.

The particle size and density details of some of the powders used are as given below in Table 1. Example compositions of some parts of the graded structure along with the base surface and arcing surface are as given in Table 2. One skilled in the art will appreciate that different particle sizes and particle densities may be used to formulate the graded structure. Further, the number of graded regions and the composition and structure of base surface, arcing surface, and graded regions may be varied as a result of routine experiments to form a further improved contact tip structure.

TABLE 1

| | Size | Apparent Density |
|---|---|---|
| Material | (microns) | (g/cc) |
| Silver | 6.0-9.0 | 1.7-2.2 |
| Tungsten | 4.5-5.5 | 2.9-3.7 |
| Tungsten Carbide | 1.5-7.0 | 4.0-4.7 |
| Nickel | 4.0-7.0 | 1.9-2.7 |
| Graphite | 40.0-45.0 | 1.9-2.2 |

TABLE 2

| Base | Example Compositions of | | Arcing |
|---|---|---|---|
| Surface | Graded Contacts | | Surface |
| 100% Cu | Ag (40-90 | wt %)—Ni (60-10 wt %) | 100% Ag |
| 100% Cu | Ag (15-50 | wt %)—WC (85-50 wt %) | 100% Ag |
| 100% Cu | AgC (93-99 | wt %)—C (7-1 wt %) | 100% Ag |
| 100% Cu | Ag (15-50 | wt %)—W (85-50 wt %) | 100% Ag |

Primarily three methods for the formation of the above-mentioned graded structure were explored. A press-sinter-repress (PSR) method was utilized using a uniaxial load of about 6-12 ton over a cross-sectional area of about 50-130 mm² to initially compact the base surface, graded structure, and arcing surface together. The compacted structure was sintered in a temperature range from about 650° C. to about 1000° C. for a time duration from about 10 minutes to about 60 minutes in an inert atmosphere of about 2-4% hydrogen in nitrogen or argon. The sintered structure was then further pressed with a pressure of about 36 to 60 ksi using cold iso-static pressing method.

In another method, spark plasma sintering (SPS) method was used to join the base surface and arcing surface using a graded structure. A pressure of about 30-50 MPa and an effective sintering temperature from about 650° C. to about 775° C. was used for a hold time of about 2-10 minutes duration to compact the structure.

In a hot iso-static pressing (HIP) method, the starting powders and blends were subjected to a uniaxial load of about 6-12 tons over a cross-sectional area of about 50-130 mm² for initial pressing, and then further pressed at a temperature range from about 650° C. to about 750° C. at a pressure range from about 20 ksi to about 30 ksi for about 1-3 hours' time duration.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a contact tip comprising
an arcing surface;
a base surface; and
a graded structure between the arcing surface and the base surface, wherein the graded structure comprises:
a first region comprising a first surface proximate to the arcing surface;
a second region comprising a second surface proximate to the base surface; and
an intermediate region disposed between the first region and the second region, wherein a concentration of silver in the graded structure decreases from the first surface to the second surface.

2. The system of claim 1, wherein the graded structure comprises a continuously graded architecture between the arcing surface and the base surface.

3. The system of claim 1, wherein a concentration of copper in the graded structure decreases from the second surface to the first surface.

4. The system of claim 1, wherein the arcing surface comprises substantially 100% silver.

5. The system of claim 1, wherein the base surface comprises substantially 100% copper.

6. The system of claim 1, wherein the graded structure further comprises tungsten, tungsten carbide, molybdenum, nickel, carbon, or a combination of the foregoing.

7. The system of claim 1, wherein the graded structure comprises a metal mixture.

8. The system of claim 7, wherein the metal mixture comprises a metal carbide, a silver-tungsten alloy, a silver-nickel alloy, silver tungsten carbide composite, silver molybdenum composite, or a combination of the foregoing.

9. The system of claim 7, wherein a concentration of the metal mixture in the intermediate region is substantially higher than the concentration of the metal mixture at the second region.

10. The system of claim 7, wherein the graded structure comprises a gradation in the composition of the metal mixture.

11. The system of claim 7, wherein the first region comprises a silver-nickel metal mixture; the intermediate region comprises a silver-copper-nickel metal mixture; and the second region comprises substantially copper.

12. The system of claim 7, wherein the first region comprises a silver-tungsten metal mixture; the intermediate region comprises a silver-copper-tungsten metal mixture; and
the second region comprises substantially 100 wt % of copper.

13. The system of claim 7, wherein the first region comprises a silver graphite metal mixture in the first region; the intermediate region comprises a silver-copper carbide metal mixture; and the second region comprises substantially 100 wt % copper.

14. The system of claim 7, wherein the first region comprises a silver-tungsten carbide metal mixture in the first region; the intermediate region comprises a copper-tungsten carbide-tungsten metal mixture; and the second region comprises substantially 100 wt % copper.

15. The system of claim 7, wherein the first region comprises a silver-tungsten carbide metal mixture in the first region; the intermediate region comprises a copper-tungsten carbide-silver metal mixture; and the second region comprises substantially 100 wt % copper.

16. The system of claim 7, wherein the first region comprises a silver-tungsten carbide metal mixture in the first region; the intermediate region comprises a copper-tungsten carbide metal mixture; and the second region comprises a copper-tungsten carbide metal mixture.

17. The system of claim 7, wherein the first region comprises a silver-tungsten carbide-tungsten metal mixture in the first region; the intermediate region comprises a copper-tungsten carbide-tungsten metal mixture; and the second region comprises a copper-tungsten carbide metal mixture.

18. A method of forming a contact tip, the method comprising:
preparing starting materials for a first region, an intermediate region, and a second region of the contact tip;
sequentially adding the starting materials of the first, intermediate, and second regions to a container to form a graded blend of starting materials; and
compacting and heat-treating the graded blend in the container to form the contact tip comprising a graded structure, such that a concentration of silver in the graded structure decreases from the first region to the second region.

19. The method of claim 18, wherein the graded blend is compacted using spark plasma sintering.

20. The method of claim 18, wherein the graded blend is compacted using hot isostatic pressing (HIP).
